(19) United States
(12) Patent Application Publication
(10) Pub. No.: US 2009/0031491 A1
(43) Pub. Date: Feb. 5, 2009

(54) System And Method For Controlling The Environment Of A Steambath

(75) Inventors: Mitchell Altman, Woodland Hills, CA (US); Scott Sharitz, Oxnard, CA (US)

Correspondence Address: SELDON & SCILLIERI, 10940 WILSHIRE BLVD., 18TH FLOOR, LOS ANGELES, CA, 90024-3952, US

(73) Assignee: Mitchell Altman, Simi Valley, CA (US)

(21) Appl. No.: 12/179,498

(22) Filed: Jul. 24, 2008

Related U.S. Application Data
(60) Provisional application No. 60/953,155, filed on Jul. 31, 2007.

(51) Int. Cl. A47K 3/28; H04R 3/00

(52) U.S. Cl. 4/597; 381/110

(57) ABSTRACT

A steambath system is responsive to verbal commands to control the various aspects of the shower and steam environment such as water flow rate, water temperature, steam activation/de-activation, lighting intensity and/or color, music volume, music content, quantity and type of fragrance released, showerhead selection, radio activation, volume and station selection, television activation, volume and channel selection, DVD player activation and DVD selection, CD player activation and CD selection, and humidity control.

The system comprises (1) microphone means capable of converting audio signals into electrical signals and having output means for transmission of the electrical signals, (2) a voice recognition circuit having an input and an output, the input being operably connected to the microphone means output, the voice recognition circuit converting the transmitted electrical signals into digital output signals, (3) a computer processing unit operably connected to the output of the voice recognition circuit for responsive controlling of at least one control unit, the computer processing unit having an output port for transmission of control signals for said purpose; (4) a network having an input terminal and one or more output terminals, the input terminal operably connected to the output port of the computer processing unit; and (5) one or more control units, each control unit operably connected to an output terminal of the network, each control unit capable of adjusting ancillary units; wherein the microphone is located to be in audio communication with the steam room and is capable of converting audio waves in the steam room into electrical signals.

### BACKGROUND OF THE INVENTION

1. Field of the Invention

This invention relates to steambath systems and, more specifically, to steambath systems having apparatus capable of being controlled by an operator.

2. Description of the Prior Art

Steam showers have been known for many years. The operation of steam showers was first accomplished using manual switches and/or mechanical timers to control steam-generating units. The more advanced steam shower systems comprised manually controlled wire control units mounted inside the steam enclosure. These manual controls were capable of controlling the steam generating units and other accessories such as music, lights, telephone answering devices and other apparatus. Other systems have included wireless manually operable remote controls that are compatible feature-wise with the wired controlled units.

The controllability of the manually controllable wired and wireless systems is somewhat limited. For example, the user must be physically located in near proximity to the control unit in order to manually operate it. With respect to wireless control apparatus, a user may locate a manually operable remote control unit in a first location but from time to time be located in a second location. In the event of a desire to change the settings of the control unit, the user will thus be required to physically relocate to the first location so that he may manually adjust the remote control apparatus.

### SUMMARY OF THE INVENTION

The invention herein enables the user to control the steambath system (as well as desired accessories) using verbal commands. The invention is capable of interpreting the verbal commands and thus to control the various aspects of the shower and steam environment (hereinafter, “steam environment”).

As used herein, the term “steam environment” shall be used to refer to the controlled parameters of the steam room environment. Depending on the user's set-up, these can include, but are not limited to, water flow rate, water temperature, steam activation/de-activation, lighting intensity and/or color, music volume, music content, quantity and type of fragrance released (i.e., the fragrance choice and quantity of fragrance to be dispersed), showerhead selection (e.g., rain, waterfall, spray, massage; vertical message), radio activation, volume and station selection, television activation, volume and channel selection, DVD player activation and DVD selection, CD player activation and CD selection, and humidity control. Further, it is understood that the selection of a shower message may also include selection of the massage frequency and/or strength. Those skilled in this art will understand that these parameters are controlled by ancillary control units that are ultimately responsive to the voice command.

Apparatus for controlling the ancillary units comprises: microphone means capable of converting audio signals into electrical signals and having output means for transmission of the electrical signals; a voice recognition circuit having an input and an output, the input being operably connected to the microphone means output and the voice recognition circuit being capable of converting the transmitted electrical signals into digital output signals; a computer processing unit operably connected to the output of the voice recognition circuit for responsive controlling of at least one control unit, the computer processing unit having an output port for transmission of control signals for said purpose; a network having an input terminal and one or more output terminals, the input terminal operably connected to the output port of the computer processing unit; and one or more control units, each control unit operably connected to an output terminal of the network, each control unit capable of adjusting ancillary units; wherein the microphone is located to be in audio communication with the steam room and is capable of converting audio waves in the steam room into electrical signals.

In a preferred embodiment of the invention, the invention is capable of providing audio information to the user confirming system status as well as other information. In another preferred embodiment, the audio information comprises voice generated audio.

An objective of the present invention is to promote the comfort, relaxation, and rest of the user, and specifically to provide a voice controllable steam bath system for the user, so that there is no requirement of moving locations to adjust the control unit.

Another objective of the invention is to provide a steambath system that is easy to operate, safe and manufacturable at a reasonable cost. Other objects and features of the invention will be appreciated by those having ordinary skill in the art from the figures and description set forth below.

Greater details of the invention will be given herein below in the following description of the preferred embodiment thereof of which the accompanying drawings form a part. Neither the description of the preferred embodiment nor the accompanying drawings are to be construed to limit the invention. Rather, the scope of this invention is intended to be limited only by the prior art.

### BRIEF DESCRIPTION OF THE DRAWINGS

FIG. 1 is a block diagram comprising the invention in partial schematic form;

FIG. 2 is a block diagram illustration of the operational steps in a preferred system constructed in accordance with the invention; and

FIG. 3 is a schematic illustration of the microprocessor circuitry utilized in the preferred embodiment of the invention.

As will be appreciated, the Figures depict the invention in schematic form for the sake of clarity, and identify various features thereof. The figures are not necessarily to scale and are described in more detail below.

### DESCRIPTION OF THE PREFERRED EMBODIMENT

The present invention will now be described more fully herein after with reference to the accompanying drawings, in which a preferred embodiment of the invention is shown. The invention may, however, be embodied in many different forms and should not be construed as limited to the embodiments set forth herein; rather, these embodiments are provided so that this disclosure will be thorough and complete, and will fully convey the scope of the invention to those skilled in the art.

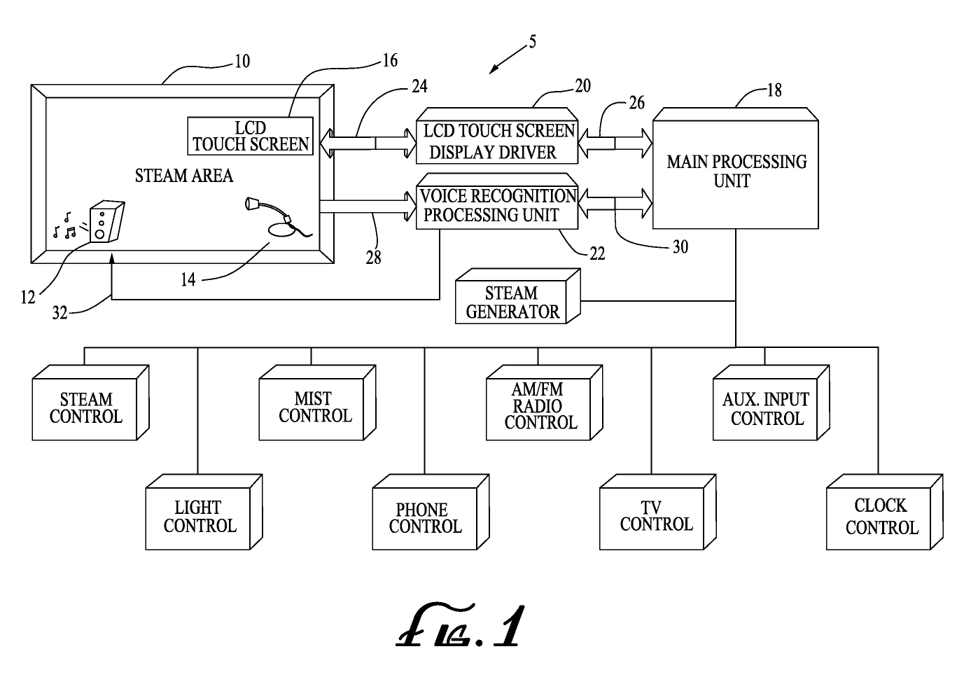

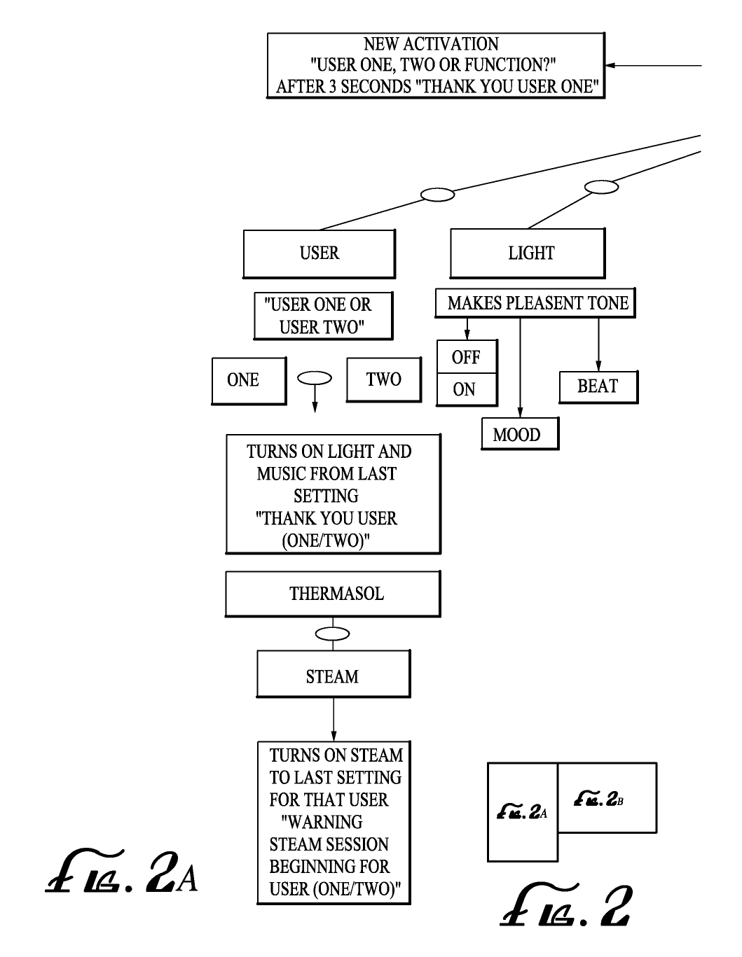

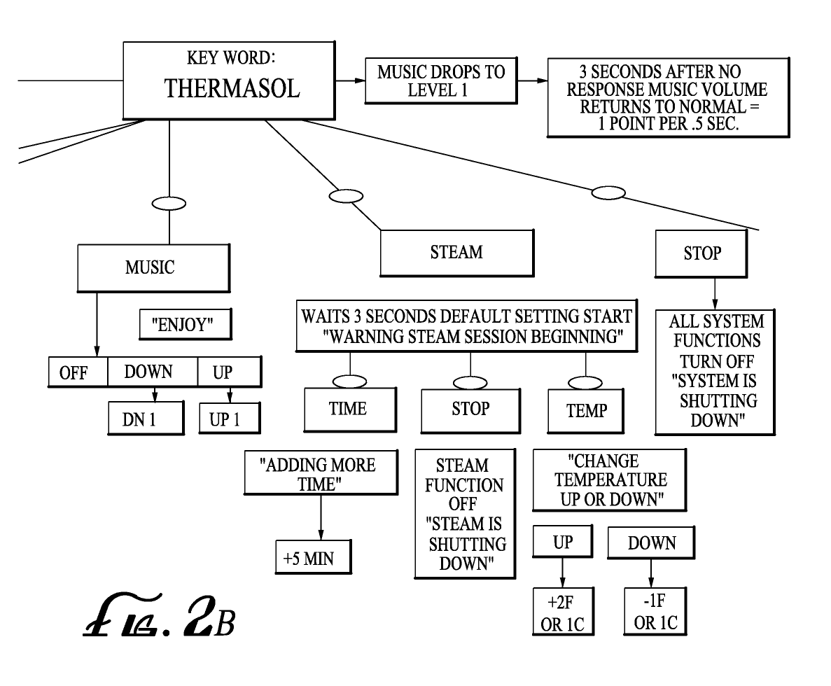

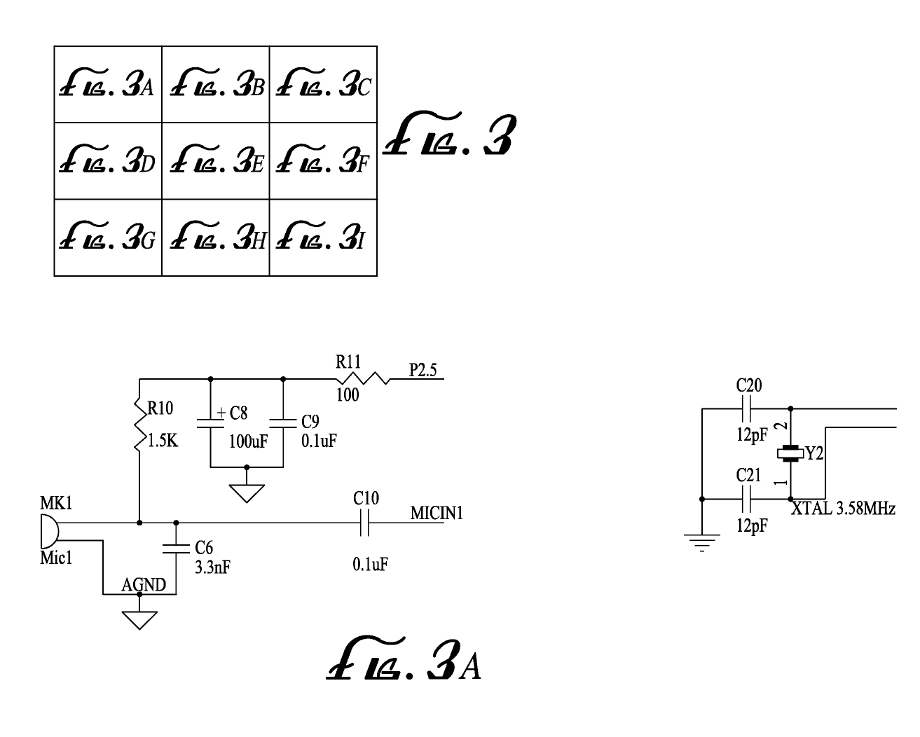

Referring initially to FIG. 1, there is depicted therein a shower/steam enclosure 10 having one or more speakers 12, a microphone 14 and an LCD touch screen apparatus 16. Also depicted in FIG. 1 are main processing unit 18, LCD touch screen display driver 20 and voice recognition processing unit 22. The LCD touch screen display driver 20 communicates with LCD touch screen 16 and main processing unit 18 by means of communication channels 24 and 26, respectively. The microphone 14 is in communication with voice recognition processing unit 22 by means of communication channel 28 and the voice recognition processing unit 22 is in two-way communication with main processing unit 18 by means of communication channel 30.

As will also be appreciated by those having ordinary skill in the art, two-way communication channel 24 permits LCD touch screen 16 and LCD touch screen display driver 20 to be in two-way communication. As will be appreciated, a user may enter commands at LCD touch screen 16 which will be communicated to LCD touch screen display driver 20. Conversely, information for video display transmitted by LCD touch screen display driver 20 may be communicated to LCD touch screen 16 by means of communication channel 24. Although an LCD touch screen is currently preferable, it should be recognized that other types of displays and input devices are within the scope of the invention.

As will further be appreciated to those having an ordinary skill in the art, two-way communication channel 24, two-way communication channel 26, two-way communication channel 22 and communication channel 28 may comprise a hardwired system or the radio frequency coupling or any other type of communication channel capable of carrying audio or digital information may be utilized.

As will be appreciated by those having an ordinary skill in the art, two-way communication channel 26 is capable of transferring information or commands between LCD touch screen display driver 20 and main processing unit 18. Two-way communication channel 22 is also capable of transferring audio or digital information between voice recognition processing unit 22 and main processing unit 18.

Audio information received by microphone 14 is transferred to voice recognition processing unit 22 by means of communication channel 28. Voice recognition processing unit 22 is capable of recognizing the appropriate audio input, converting the audio input to digital signals which are transferred over communication channel 30 to main processing unit 18 for processing. Voice recognition processing unit 22 communicates with speaker 12 by means of communication channel 32. Voice recognition processing unit 22 receives digital signals from main processing unit 18 which it is capable of decoding and encoding into audio signals which are transferred over communication channel 32 to speaker 12.

Thus, a user in the steam enclosure 10 is capable of issuing commands by means of the LCD touch screen 16 as well as audio commands by means of the microphone 14. Commands issued by means of the LCD touch screen 16 are transferred by means of communication channel 24 to the LCD touch screen display driver 20 which then processes the input from the LCD touch screen and converts it to an output recognizable by the main processing unit 18 and that output is communicated to the user by means of communication channel 26 to main processing unit 18. Similarly, main processing unit 18 is capable of providing information to the user by means of the generation of digital information over communication channel 26 to the LCD touch screen display driver 20 which then converts the signals and transmits them over communication channel 24 to LCD touch screen 16 which then displays the desired information. Similarly, the main processing unit 18 is capable of generating signals convertible into audio information which are communicated to the voice recognition processing unit 22 by means of communication channel 30. The voice recognition processing unit 22 processes such digital signals and converts the signals to appropriate signals transmitted over communication channel 32 to speaker 20 and such converted signals are converted by speaker 20 into audio information understandable by the user.

Thus, it will be appreciated that the user may provide digital input commands as well as audio commands into the system and the system is capable of communicating with the user by means of information displayed on the LCD touch screen 16 as well as audio information which is converted from electronic signals to audio by means of speaker 20 or any other type of electrical-audio transducer.

Another feature of the instant invention resides in the use of voice and/or keypad activated baffles to control the steam environment parameter of steam density. Because steambath “fog” actually dissipates as humidity approaches 100%, colder dryer air is controllably introduced into the environment to maintain the desired level of fog.

Additional voice and/or keypad activated features may include the following steam environment parameter controls:

timer settings to control steambath time and/or steambath phases,

telephonic communications, preferably Blue Tooth® cell phone communication,

paging service for service staff

soap/shampoo dispensing

entry control systems for communicating with, and selectively permitting entry of, visitors to the residence,

voice recognition circuitry that is responsive to specific user(s) whose tone and inflection is recognized, and which can use such recognition to address each such user by name, and to set customized default steambath parameters, and

circuitry which interacts with a master home computer system of the “smart house” type that controls activities and environment in the residence.

With regard to “smart house” systems, the invention herein includes a “smart house module” that can be connected between the “smart house” microprocessor and the steam generator of an existing steam bath system to make the resulting steam bath environment voice responsive without necessitating the replacement of its steam generator. In accordance with the invention, all communications and data may be transferred via a serial network or an analog data stream.

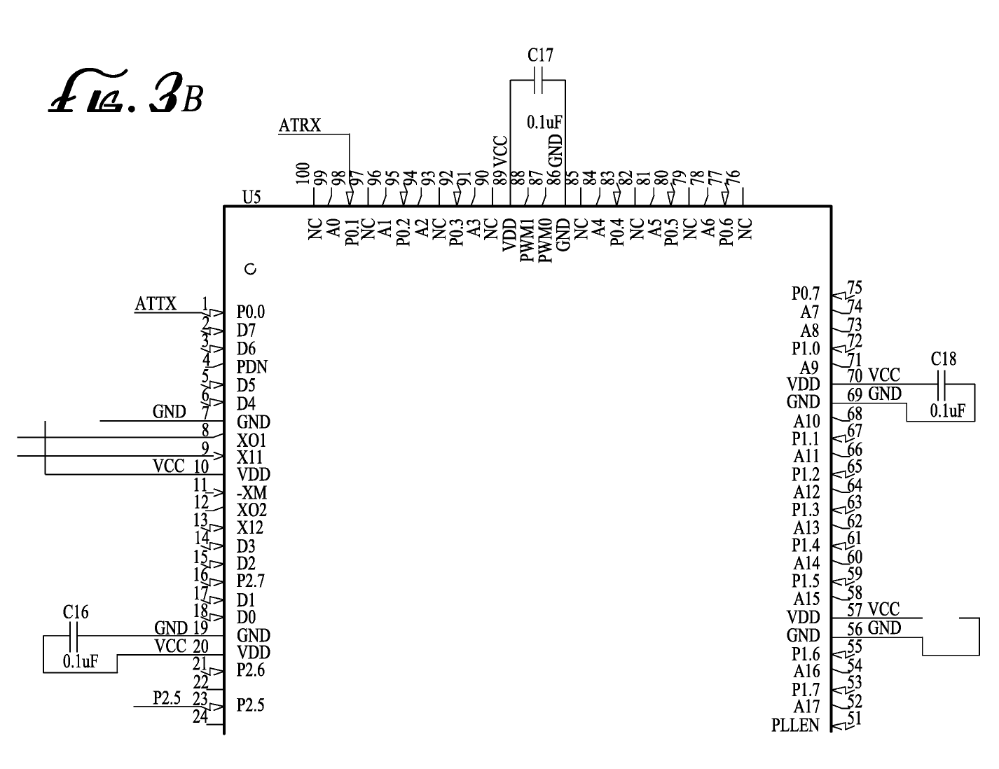

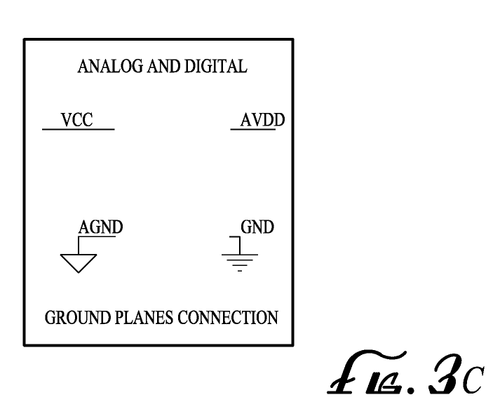

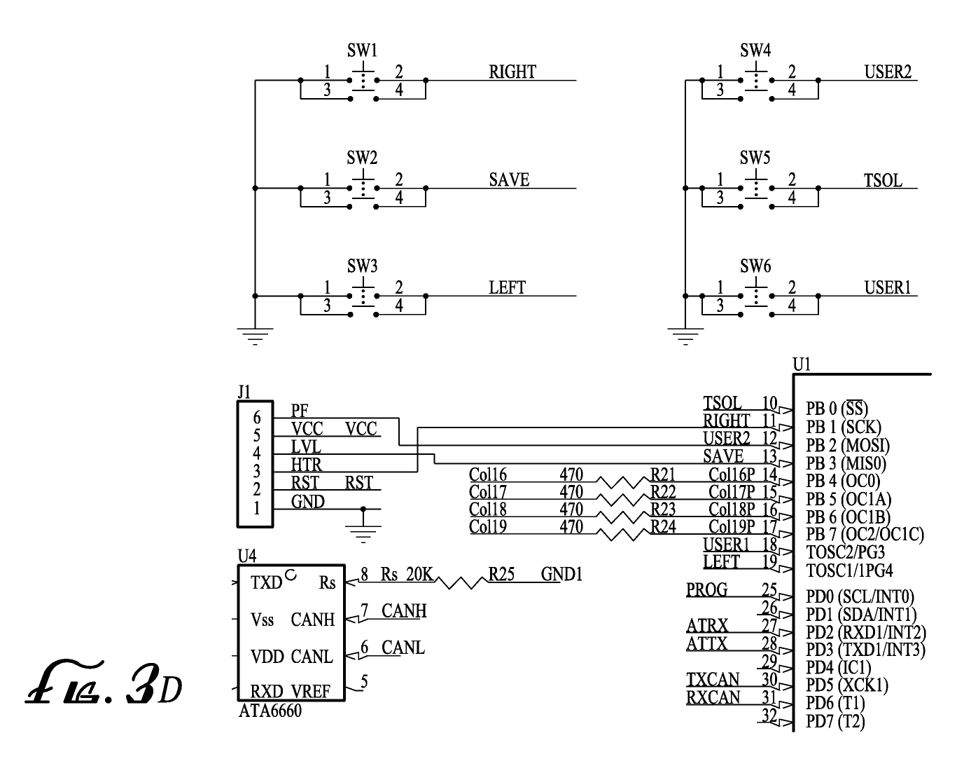

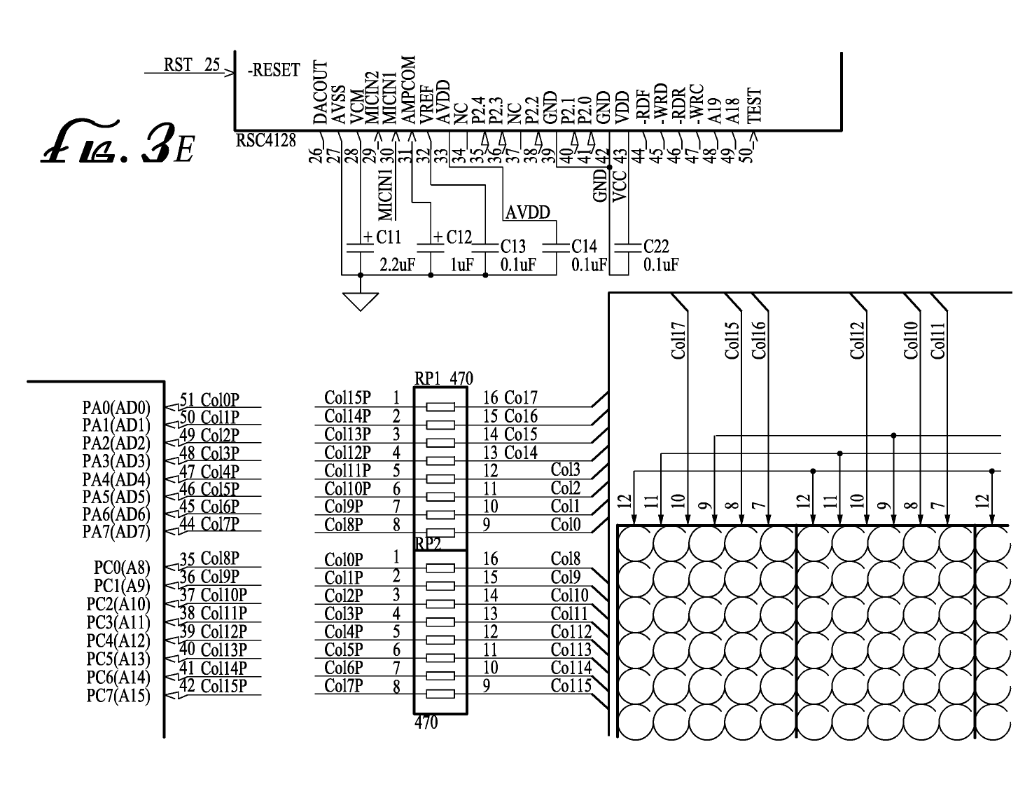

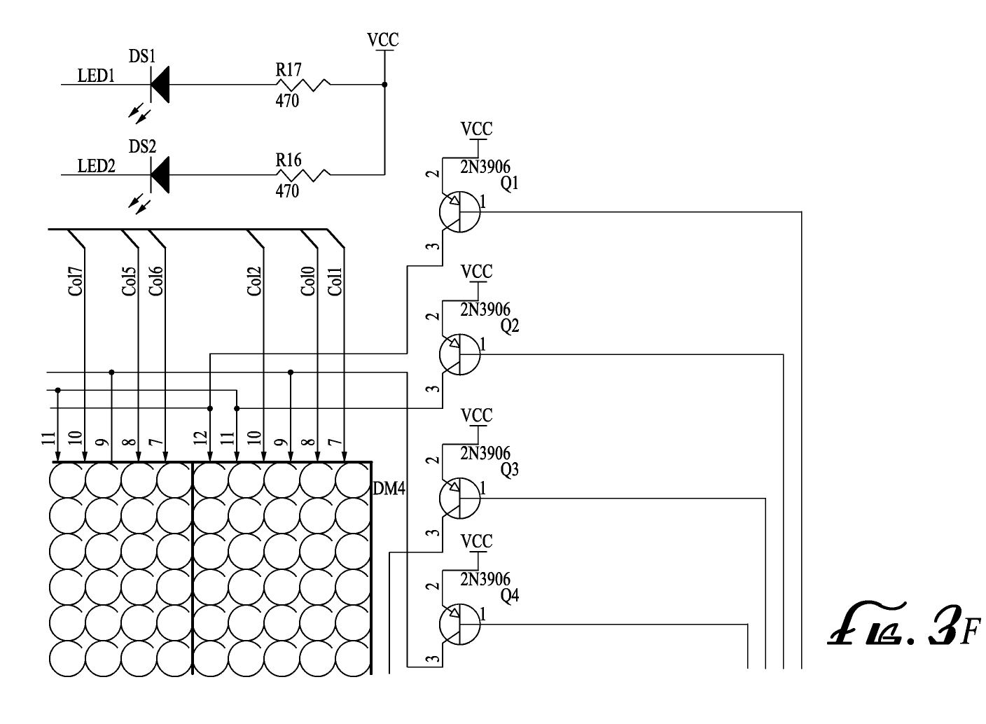

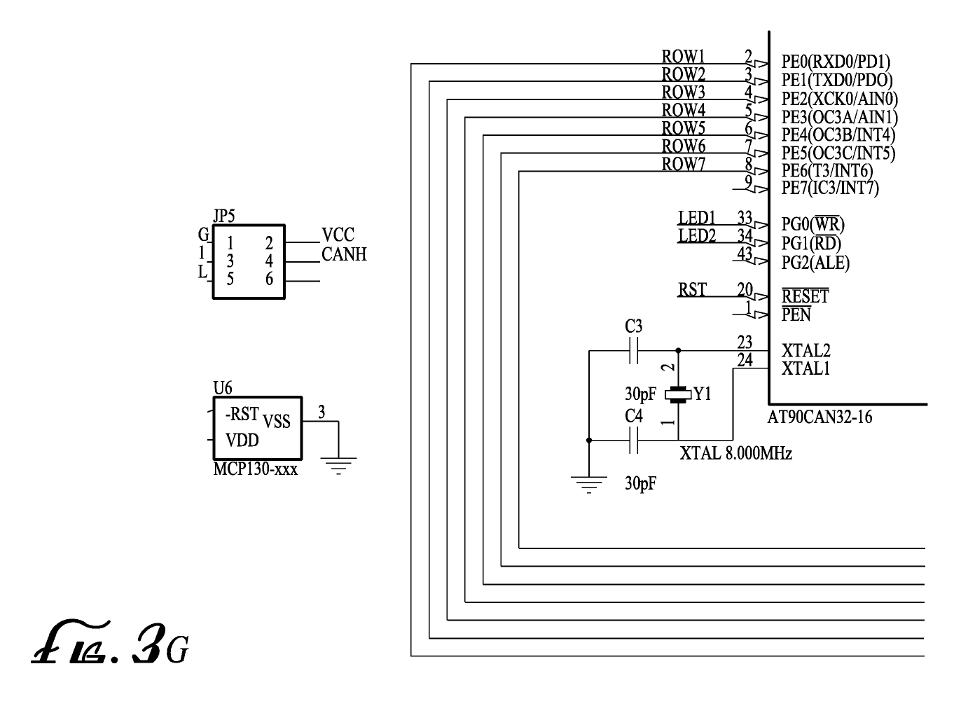

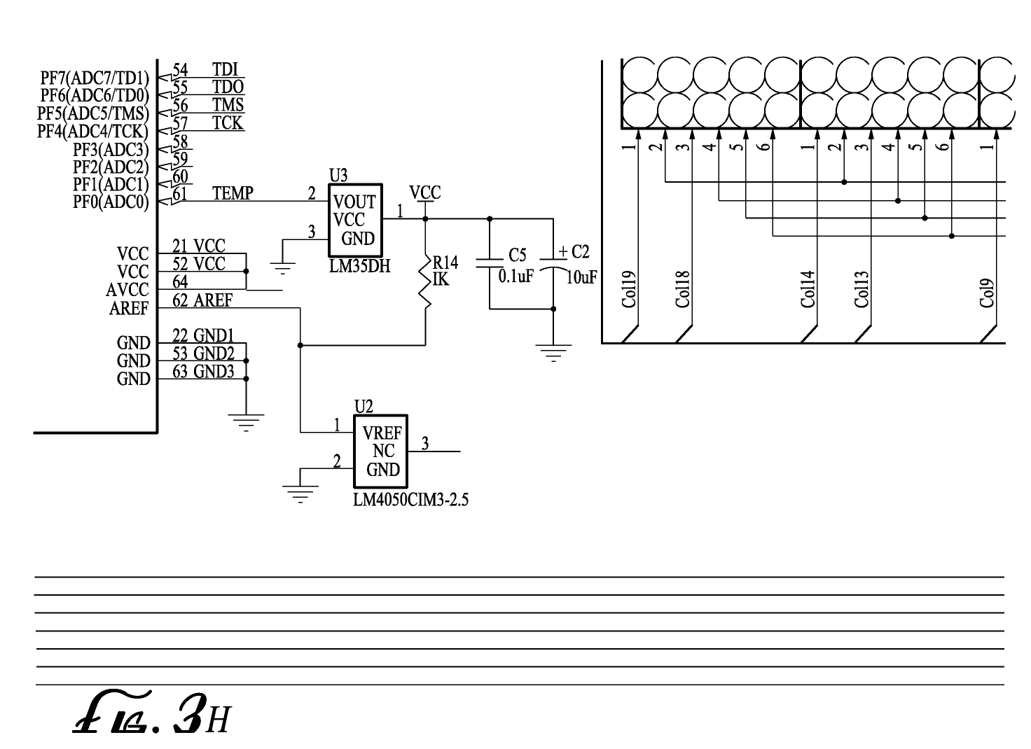

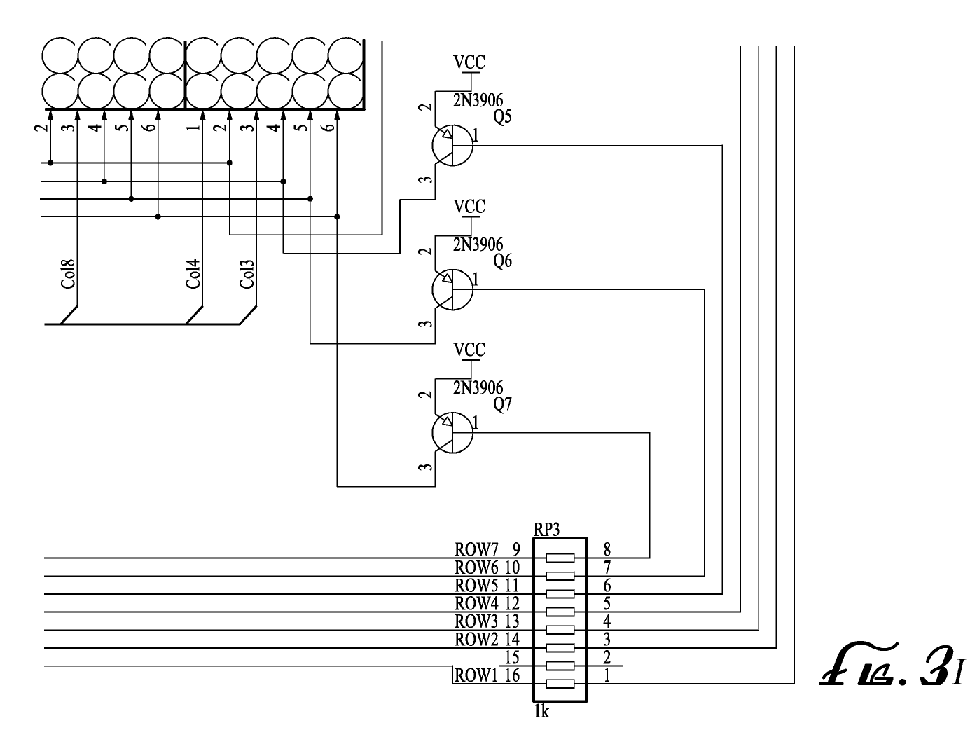

Turning to FIG. 2, a block diagram illustration is shown of the operational steps in a preferred system constructed in accordance with the invention. Voice controls are shown in bold font, with the system's verbal responses shown in light font. Naturally, both the commands and responses can be different without departing from the scope of the invention.

A user activates the system by saying a keyword that has been programmed into the system; e.g., “Thermasol”, followed by a command such as “user”, “light”, “music”, “steam”, or “stop”. The system responds as illustrated, with the user thereafter having the illustrated choices followed, if appropriate, by the illustrated further system response(s) and user-generated reply(ies).

Although the present invention and its advantages have been described in detail, it should be understood that various changes, substitutions and alterations can be made herein without departing from the spirit and scope of the invention as defined by the appended claims.

I claim:

1. An apparatus for controlling the steam environment of an enclosure sufficiently sized to enclose a human user, comprising
a central processing unit having first input port means capable of processing an electrical signal corresponding to at least one audio command, second input port means capable of processing an electrical signal corresponding to at least one mechanically generated command, third input port means capable of processing a temperature indicative electrical signal corresponding to a temperature within the enclosure, and at least one output port means, the central processing unit being capable of generating an output command signal at said at least one output port means in response to at least one input signal at at least one input port means;
first transducer means in operable communication with the first input port means of the central processing unit, and capable of generating a first electrical signal in response to an audio signal from within the enclosure;
second transducer means in operable communication with the second input port means of the central processing unit, and capable of generating a second electrical signal in response to a mechanically generated command by the user from within the enclosure;
a temperature sensor in operable communication with the third input port means of the central processing unit, and capable of generating an electrical signal responsive to the temperature within the enclosure; and
a steam generator in operable communication with at least one output port means of the central processing unit, and having an output vent for releasing steam under control of an output command signal generated by the central processing unit.

2. The apparatus of claim 1 wherein the first transducer means is a microphone.

3. The apparatus of claim 1 wherein the second transducer means is a touch screen.

4. The apparatus of claim 1 including voice recognition circuitry for digitizing said first electrical signal, and
means responsive to said digitized first electrical signal to generate a corresponding output command.

5. The apparatus of claim 1 including:
at least one control unit responsive to at least one output command signal from the central processing unit to vary at least one parameter of the steam environment;
voice recognition circuit means having an input and an output, the input being operably connected to the first transducer means to convert audio signals corresponding to at least some spoken words into respective digital output signals;
said central processing unit being operably connected to the output of the voice recognition circuit means for responsive controlling of said at least one control unit,

6. The apparatus of claim 5 including a network having an input terminal means and one or more output terminal means, the input terminal means being operably connected to an output port means of the central processing unit;
said at least one control unit being operably connected to a respective output terminal of the network, each control unit being capable of adjusting a respective parameter of the steam environment.

7. The apparatus of claim 6 including means within the central processing unit for providing audio information to the user concerning at least one user-generated command entered at at least one of the first and second transducer means.

8. For use with a shower/steam enclosure, a system for use by a human user to control the steam environment within the enclosure and comprising:
speaker means for accepting verbal user-generated commands pertaining to the steam environment;
a touch screen display apparatus for accepting user commands entered by the user and pertaining to the steam environment;
a touch screen display driver configured for two-way communication with the touch screen, said touch screen being configured to communicate said commands to the touch screen driver and to display images communicated to it by the touch screen driver;
a voice processing unit in two-way communication configuration with said speaker means for processing said verbal user-generated commands; and
a main processing unit in communication with said speaker means, touch screen driver and voice recognition unit to generate control signals in response to user-generated commands for controlling the steam environment, said main processing unit being adapted to communicate said control signals to at least one steam-environment parameter controlling actuator.

9. The system of claim 8 including
first communication channel means linking the touch screen display driver and the touch screen so that information pertaining to displayed images is transferred to the touch screen.

10. The system of claim 9 wherein said first communication means links the touch screen display driver and the touch screen so that information pertaining to user-entered commands at the touch screen is transferred to the touch screen display driver.

11. The system of claim 9 wherein the first communication means includes a hard-wired communication channel.

12. The system of claim 11 wherein the first communication means utilizes radio-frequency coupling to transfer the information.

13. The system of claim 9 wherein the first communication means utilizes radio-frequency coupling to transfer the information.

14. The system of claim 8 including second communication channel means linking the speaker means with the voice processing unit so that information pertaining to verbal user-generated commands images is transferred to main processing unit.

15. The system of claim 14 wherein said second communication means links the speaker means with the voice processing unit so that information pertaining to user-entered commands is transferred to the speaker means from the central processing unit for verbal communication to the user.

16. The system of claim 14 wherein the second communication means includes a hard-wired communication channel.

17. The system of claim 16 wherein the second communication means utilizes radio-frequency coupling to transfer the information.

18. The system of claim 14 wherein the second communication means utilizes radio-frequency coupling to transfer the information.
